(19) United States
(12) Patent Application Publication
(10) Pub. No.: US 2018/0214953 A1
(43) Pub. Date: Aug. 2, 2018

(54) METHOD FOR MANUFACTURING PARTS MADE BY POWDER METALLURGY COMPRISING THE APPLICATION OF A COATING

(71) Applicant: SAFRAN AIRCRAFT ENGINES, Paris (FR)

(72) Inventors: Stephane KNITTEL, Saint-Fargeau-Ponthierry (FR); Philippe BAYARD, Alfortville (FR); Cedric Pierre Jacques COLAS, Saint Germain Les Corbeil (FR)

(21) Appl. No.: 15/884,244

(22) Filed: Jan. 30, 2018

(30) Foreign Application Priority Data
Jan. 30, 2017 (FR) 1750709

(51) Int. Cl. B22F 3/24; B22F 5/00; B33Y 80/00

(52) U.S. Cl. CPC B22F 3/24; B22F 5/009; B22F 2003/242; B22F 2303/20; B33Y 80/00

(57) ABSTRACT

Method for manufacturing a turbine engine part, said method comprising a step (101) of producing said part by powder metallurgy using a material forming the substrate of said part, then a finishing operation comprising at least one first step (103), in which a determined material is deposited onto at least one surface (S1) of the substrate of said part after the powder metallurgy production step (101), and a second step (104) corresponding to a heat treatment operation, so as to form a smooth coating for said surface (S1), characterised in that said determined material is a metal material, so as to form a metal coating.

### TECHNICAL FIELD

The field of the present invention is that of manufacturing metal parts and, more specifically, that of finishing treatment for obtaining a good surface condition on parts produced by powder metallurgy.

### PRIOR ART

The prior art comprises the patent applications published under numbers US-A1-2015/060403, US-A1-2013/071562, FR-A1-3028436 and FR-A1-2994397, as well as the patent published under U.S. Pat. No. 6,409,795.

The production of parts by powder metallurgy offers a clear economic advantage in terms of the production rate, of reducing the times of the machining steps and of the production cost.

Powder metallurgy manufacturing methods particularly comprise methods for additive manufacturing or direct manufacturing, such as laser sintering melting, powder injection moulding or electron beam melting, for example. These methods have the advantage of being able to produce metal parts from metal powders which have a geometry that is close to the final geometry of the part.

However, the surface conditions on completion of the method do not allow the parts to be used directly. Indeed, surface conditions exhibiting high and uneven levels of roughness are generally obtained depending on the production method, the construction parameters and orientation and the type of powders used (grain size, particle size distribution and chemical composition). These surface conditions prove to be incompatible with the design office requirements with respect to roughness (impact on aerodynamic performance levels in the flow path zones), but also with respect to mechanical fatigue (parts subject to vibrating stresses during operation) associated with these degraded surface conditions.

Furthermore, the surfaces of parts produced by additive manufacturing are generally polluted (oxides, grains of poorly adhering powder) or exhibit metallurgical defects that can affect the microstructure of the part at thicknesses generally ranging between 50 and 200 μm.

Techniques exist that allow the surface conditions of parts produced by additive manufacturing to be improved by removing material on the surface of the parts, in order to obtain surfaces that are compatible with the requirements stipulated by the design office. These methods can be mechanical (method for modifying surface conditions by machining or vibratory finishing), chemical (chemical or electrochemical machining), or even a combination of methods belonging to the two aforementioned groups. For parts with complex geometries, these methods can be limited in terms of effectiveness and accessibility.

Another group of methods can, as disclosed in document FR-B1-2978687 of the applicant, comprise manufacturing a part by powder metallurgy having an under-thickness, followed by a finishing operation involving the deposition of an epoxy paint coating to form a film that allows the desired position of the surface of the part to be obtained. Depositing epoxy paint is easier to perform and allows good surface conditions to be produced on completion of manufacturing. However, the disadvantage of this method is that the coating does not have the same mechanical, thermal and chemical resistance qualities as the substrate of the part obtained by powder metallurgy. It is instead reserved for prototype parts, but does not necessarily have the characteristics to produce a part intended to function during operational use. Indeed, applying a layer of organic epoxy paint can smooth the surface, or even provide the substrate with a certain amount of corrosion resistance. However, the use remains limited to a maximum of 150/200° C. Furthermore, in the flow path zones, epoxy resin-based organic paints exhibit poor erosion performance.

The aim of the present invention is to overcome these disadvantages by proposing a method for producing rapid construction parts from metal powders, which method does not have some of the disadvantages of the prior art and which, in particular, allows high-quality surface conditions to be obtained and effective protection of the part during use.

### DISCLOSURE OF THE INVENTION

To this end, the subject matter of the invention is a method for manufacturing a turbine engine part, said method comprising a step of producing said part by powder metallurgy having a material forming a substrate of said part, then a finishing operation comprising at least one first step, in which a determined material is deposited onto at least one surface of the substrate of said part after the powder metallurgy production step, and a second step, corresponding to a first heat treatment operation, so as to form a smooth coating for said surface, characterised in that said determined material is a metal material, so as to form a smooth metal coating.

The use of a metal material allows a metal coating to be formed that provides the part with an improved surface topography compared to an untreated part and with enhanced mechanical resistance due to said improvement of the surface topography (better vibrating resistance, for example).

Preferably, said metal material is deposited in the form of powder during said first finishing step.

Advantageously, a binding agent or adhesive is used during said first finishing step, so as to promote the adhesion of the metal powder material on said surface of the substrate.

Advantageously, the material of the substrate being a determined metal or metal alloy, said metal powder material comprises at least one first set of grains made up of a first metal or a first alloy of the same nature as the material of the substrate. This allows a metallurgical continuity to be obtained between the substrate and the coating, thus allowing equivalent properties to be obtained between the substrate and the coating, promoting the operational effectiveness of the part.

Preferably, the heat treatment operation of said second finishing step is performed so as to melt at least one set of grains of the same nature in said metal powder material.

Advantageously, the first set of grains differs from the set of grains melted in said second finishing step.

Advantageously, said surface of the substrate having a determined roughness, the particle size of said first set of grains is smaller than said roughness, preferably smaller than 53 μm, so as to form drops of liquid material properly filling the roughness of the surface of the substrate during said second finishing step.

Preferably, the method comprises a step of cleaning said surface of the substrate before said first finishing step, so as to promote the adhesion of said metal material to the substrate.

In a first embodiment of the method, said first finishing step comprises at least one phase of depositing an adhesive agent onto said surface of the substrate prior to a phase of applying the powder of said metal material onto said surface, so that the powder adheres to said surface.

In a second embodiment of the method, said first finishing step comprises a phase of producing a slurry using the powder of said metal material, as well as at least one binding agent and a solvent, and a phase of applying said slurry to said surface of the substrate, so that the powder deposit reaches the desired thickness for forming the coating.

Advantageously, after the phase of applying said slurry to said surface of the substrate, the finishing operation comprises a step of heat-curing, so as to consolidate the powder deposit.

Preferably, the finishing operation comprises a second heat treatment operation, so as to homogenise the thickness of the coating of said surface.

Advantageously, the second heat treatment operation comprises a brazing phase and a diffusion phase.

Preferably, the finishing operation comprises a step of mechanical or chemical treatment of the coating of said surface.

### DESCRIPTION OF THE DRAWINGS

The invention will be better understood, and further aims, details, features and advantages thereof will become more clearly apparent, throughout the following detailed description of embodiments of the invention, which are provided strictly by way of illustrative and non-limiting examples, with reference to the accompanying schematic drawings, in which:

FIG. 1 is a schematic section of the surface of a part produced from metal powders, after the step of additive manufacturing;

FIG. 2 is a schematic section of the surface of the same part as FIG. 1 after the deposition of a metal powder layer, in a first embodiment of the invention;

FIG. 3 is a schematic section of the surface of the same part as FIG. 1 after the deposition of a metal powder layer using a slurry, in a second embodiment of the invention;

FIGS. 4a, 4b and 4c are schematic sections of an aspect of the surface of FIG. 1, on which different sized drops of brazed metal powder are adhered with a view to forming a layer as shown in FIG. 5;

FIG. 5 is a schematic section of the surface of the same part as FIG. 3 after a first heat treatment operation according to the invention;

FIG. 6 is a schematic section of the surface of the same part as FIG. 5 after a second heat treatment operation according to the invention;

FIG. 7 shows the workflow diagram of a first embodiment of the method according to the invention;

FIG. 8 shows the workflow diagram of a second embodiment of the method according to the invention.

### DETAILED DESCRIPTION

The invention relates to the manufacture of a part by powder metallurgy by additive manufacturing, for example, powder spraying laser manufacturing (additive laser manufacturing or ALM), selective laser melting (SLM), metal injection moulding (MIM), powder injection moulding (PIM), electron beam melting (EBM), etc. As previously mentioned, additive manufacturing thus allows a part to be formed having a metal material forming a substrate, the surface of which has a geometry that is close to the final required shape. The substrates related to by the invention can be:
nickel, cobalt, NiCr, CoCr, NiCo, CoNi, CoNiCr, nickel-based or cobalt-based alloys or nickel-based superalloys or cobalt-based superalloys;
steels (martensitic, austenitic, cast iron, etc.), FeCrAl, etc.;
titanium and titanium alloys;
intermetallic materials (TiAl, etc.).

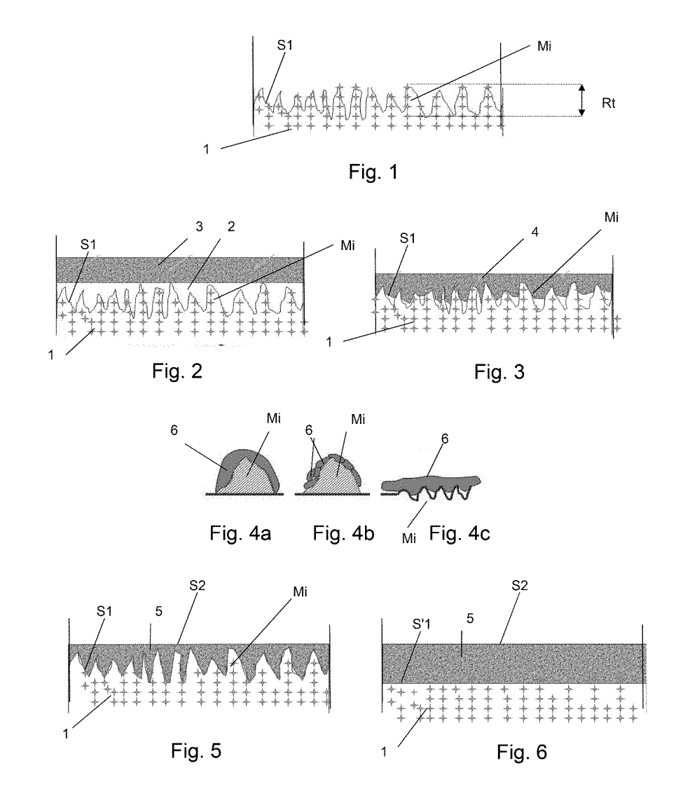

FIG. 1 shows a highly magnified section of a surface element S1 of the substrate 1 of such a part. Said surface S1 has a certain number of peaks and troughs, which extend perpendicular to the average surface of the part and for which the amplitude between the highest peak and the deepest trough, which characterises the roughness of the surface, is equal to a value Rt. Said roughness Rt also provides a characteristic dimension of the size of the patterns Mi forming the asperities of the surface S1, typically a peak between troughs.

The remainder of the method according to the invention will now be described, which method allows low surface roughness to be achieved on the surface element S1 while conforming to the shapes of the completed part. This method applies a metal coating to the surface element S1, the thickness of said coating generally being between 25 and 3000 μm, depending on whether the intention is to simply smooth the surface S1 or to also make up for a difference in dimensions relative to the shape specified for the part.

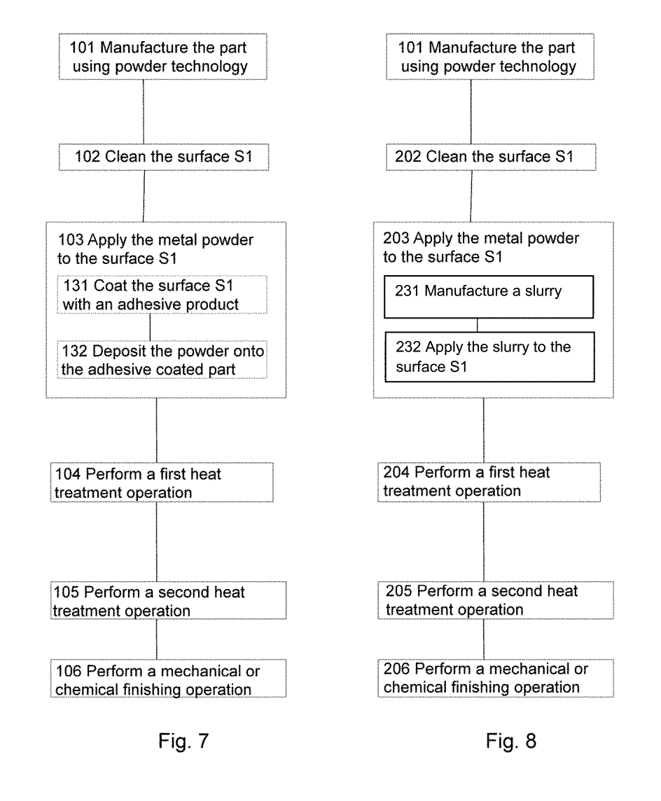

With reference to FIG. 7, a first embodiment of the method uses the application of an adhesive or glue on the surface S1 to retain a metal powder or a mixture of metal powders that are used to form the metal coating on the surface S1.

The powder or the powder mixture advantageously comprises a first powder of a first metal, of the same nature as that of the substrate 1, or a first alloy, of the same grade or of a grade close to that of the alloy of the substrate 1. This allows a coating to be formed with the same qualities as the substrate 1 of the part and ensures the metallurgical continuity between the part and the coating. Said first powder, which is generally non-meltable during heat treatment operations, such as the brazing process used in the method, preferably has a fine particle size. The size of the grains is preferably determined according to the characteristic dimension Rt of the roughness and the distance between the patterns, so that the grains of powder can be distributed on the patterns Mi forming the asperities of the surface S1. Typically, the size of the grains is smaller than 53 μm.

In view of the heat treatment operations that form part of the method according to the invention, the powder or the powder mixture preferably comprises a second powder of a second metal, which in this case is meltable and is intended for brazing. Advantageously, the solidus temperature of the second brazing metal is smaller than the solidus temperatures of the first metal and of the substrate 1. Examples of metal alloys that can be used for the second metal are provided below with their melting temperatures. The table below also includes mixtures of first and second powders or metals, as well as their melting temperatures.

| Type of alloy (second metal) or mixture | |
|---|---|
| (first metal and second metal) | Melting temperature |
| NiCrB1055 | 1100° C. |
| NiCoSiB1060 | 1125° C. |
| RBD61 (Astroloy 75% and NiCoSiB1060 25%) | 1170-1220° C. |
| RBD121 (Astroloy 70% and NiCoSiB1060 30%) | 1170° C.-1220° C. |

Advantageously, the powder mixture is placed in a mixer for a period that is required for proper homogenisation, before it is used in the steps described hereafter.

Preferably, the method comprises, after the step 101 of additive manufacturing of the part and before depositing the powder or the mixture of metal powders, a preliminary cleaning step 102 so that the surface S1 to be treated is clean, non-greasy and non-oxidised. This cleaning step 102 advantageously comprises a degreasing and deoxidising range. It is also possible for vapour phase cleaning of the fluorinated type to be added.

Subsequently, the first step 103 of producing the metal coating, in this case of applying a metal powder layer onto the surface S1, comprises two phases.

A first phase 131 involves depositing an adhesive onto the surface S1, such as glue, charcoal lacquer or hair lacquer, for example. This can be performed by atomising the adhesive in the form of a spray or by any other means (e.g.: by painting or spraying, brush, dipping).

This is immediately followed by a second phase 132 of depositing a fine layer of the powder or of the mixture of powders onto the glued surface S1. To this end, the powder can be sprinkled over the surface S1 by means of a powder distributor of the salt shaker type, in which the powder has been previously placed. The powder is then evenly distributed over the entire zone to be treated before any non-adhering excess is removed in order to leave a very fine layer of powder on the part. The thickness of the layer of powder is between 30 μm and 150 μm.

In one variant, the second phase 132 can be completed by submerging the part in a powder mixture bath (of the vibratory finishing tumbler type), in order to adhere the powder to the surface of the part.

With reference to FIG. 2, at the end of the second phase 132, the mixture 3 of metal powders adheres to a layer of adhesive agent 2, which attaches itself to the surface S1. The assembly can cover the patterns Mi of the roughness of the surface S1, with the adhesive agent 2 filling the troughs between the patterns Mi and the layer of powder of this mixture 3 not penetrating the troughs. The outer surface of the powder or of the deposited powder mixture is smoother than the surface S1 but it is not necessarily sufficiently polished, and the assembly does not yet form a coating with the desired properties.

The two phases 131, 132 of the step 103 of depositing powder can be repeated as many times as is necessary for the powder layer to reach a determined thickness, allowing, by virtue of the heat treatment operations applied during the remainder of the method, the metal coating to be produced with the desired thickness.

The method then comprises a heat treatment operation 104 for reducing the roughness and for obtaining a smooth coating for the surface S1. In this case, this involves adding energy to the surface of the metal powder layer, for example, by heat treatment in a furnace. The heat also can be applied locally using a laser to melt at least part of the deposited powder, for example, the grains of the brazing powder made up of the second meltable metal. With reference to FIG. 5, a metal coating 5 is obtained that, on the one hand, has an outer surface S2 that is smoother and has better mechanical properties and, on the other hand, conforms to the surface S1 of the substrate 1, the bonding agent having been removed.

This treatment operation can be followed by heat treatment operations 105 of diffusion and structural homogenisation. With reference to FIG. 6, the second heat treatment operations 105 can particularly allow the thickness of the metal coating 5 to be homogenised.

More generally, the part can undergo a brazing-diffusion cycle in order to optimise the smoothing of the surface S1 by the coating, as in the following example:
degassing between 400 and 600° C. for 15 minutes (step not shown in FIG. 7);
homogenisation at 950° C. for 15 minutes (step not shown in FIG. 7);
brazing at a temperature that is to be selected between 960° C. and 1220° C. for 10 to 20 minutes (step 104 shown in FIG. 7);
diffusion at a temperature that is to be selected above 1100° C. for a duration which depends on the substrate/coating pairing, lasting for 2 to 8 hours, for example (step 105 shown in FIG. 7).

Such a heat treatment cycle can be performed in a vacuum, in a neutral atmosphere or in a reducing atmosphere to limit any oxidising phenomena.

To finalise the improvement of the surface condition, a finishing treatment operation 106 can be performed. This treatment can be mechanical, for example vibratory finishing, belt sanding or light sanding, or chemical, for example chemical machining.

With reference to FIG. 8, a second embodiment of the method uses, after the additive manufacturing 101 of the part, the application of a slurry in which a metal powder or a mixture of metal powders is suspended, which powders are used to form the metal coating on the surface S1. This second embodiment can be advantageous in the case of parts with complex geometries where complex-shaped and difficult to access areas need to be covered.

As in the first embodiment, the powder or the mixture of metal powders advantageously comprises a first powder of a first metal of the same type as the metal of the substrate 1, or a first alloy having the same grade or a grade close to that of the alloy of the substrate 1.

Similarly, the powder or the mixture of powders preferably comprises a second powder formed by a second alloy having a solidus temperature below the solidus temperatures of the first metal or first alloy and of the substrate 1, with a view to heat treatment operations of the brazing type that are applied in the method. For the second embodiment, said second alloy is preferably formed using an alloy from the same group as the first alloy or the same metal as the first metal, but by modifying its composition, for example by using bodies such as Si, B, P or precious metals such as Cu, Ag, Au, Pd.

Preferably, the second embodiment also comprises, before the deposition of the powder or the mixture of metal powders, a preliminary cleaning step 202 so that the surface S1 to be treated is clean, non-greasy and non-oxidised. As in the preceding embodiment, this cleaning step 202 can comprise a degreasing and deoxidising range. It is also possible for vapour phase cleaning of the fluorinated type to be added. Advantageously, said step 202 is equivalent to decontamination and can be performed using chemical descaling of the surface S1 so as to deoxidise and activate the surface. By way of an example, for a nickel-based alloy substrate 1, a deoxidising bath containing the following mixture: HNO3/HCl/HF and FeCl3 can be used to descale the surface S1. The aforementioned step 102 can be replaced by this step 202.

This cleaning improves the effectiveness of the method by promoting good wettability of the alloys forming the powder or the mixture of powders on the surface S1 of the substrate 1. Indeed, it is known that a metal material in the liquid state has good wettability on a solid substrate made of the same material.

In the second embodiment, the step 203 of depositing the powder or the mixture of metal powders begins with a first phase 231 of manufacturing a slurry. This involves placing the mixture of metal powders in suspension in a solution or a paste, and adding a binder and solvents thereto. The binder can be an aqueous organic binder, such as a polyethylene oxide (PEO) or acrylic materials, or a metal binder, such as NiCr or NiCrSi. The solvents are generally organic solvents.

Agents, such as a wetting agent, can also be added to the mixture to allow good adhesion and better spreading of the slurry over the whole of the part.

The second phase 232 of the deposition step 203 involves applying slurry to the surface S1. This can be implemented using known methods, for example, by spraying (jet, gun), dipping or by a brush.

With reference to FIG. 3, on completion of the step 203, the layer 4 of slurry material penetrates the troughs around the patterns Mi of the surface S1, promoting its adhesion and the homogenisation of the coating during the subsequent steps of the process.

A heat-curing step, not shown in FIG. 8, can be performed in order to consolidate the deposition on the part and to allow it to be handled more easily. The curing duration can range from 10 minutes to a few hours, with a temperature ranging between 50 and 150° C., for example.

In the second embodiment, the method further comprises a heat treatment operation 204 for obtaining, as shown in FIG. 5, a homogenous metal coating 5, which conforms to the surface S1 of the substrate 1 and which has a smooth outer surface S2. In this case, the treated part is placed in a furnace in order for the coating to be assembled on the part. The temperature and the duration of the treatment for assembling the coating on the part can vary depending on the nature of the substrate and the coating. In any case, the treatment temperature must be greater than the solidus temperature of the second alloy. Intermediate temperature stages can be implemented at temperatures lower than the final treatment. The purpose of these stages is to evaporate the binder and the solvents contained in the slurry. Typically, when applying the method to a nickel-based alloy, the treatment temperatures are between 800 and 1300° C. and the durations of the stages range from 20 minutes to 2 hours.

It is to be noted at this point that, in order to promote good wettability and good adhesion of the mixture of powders, the size of the metal particles needs to be compatible with the surface condition to be covered. As shown in FIG. 4, this allows, during the heat treatment operation, melted slurry drops 6 to be obtained, the size of which allows proper filling of the roughness when warming up and melting the mixture applied to the surface of the part. FIG. 4a shows that the dimension of the drops 6 is comparable to the roughness Rt and that they thus properly distribute over the patterns Mi of the surface S1. However, in FIG. 4b, the drops 6 are too small and do not form a homogenous film, whereas, in FIG. 4c, excessively large drops 6 do not wet the troughs between the patterns Mi. The use of fine particle size powders, with grain sizes that are smaller than or equal to 53 μm, allows suitable drop sizes to be obtained. This observation is equally valid for the drops of material that are melted from the powder glued to the surface S1, during the heat treatment operation 131 of the first embodiment.

Within the context of reducing the implementation costs of the method, the heat treatment operation can be performed at the same time as a heat treatment operation intended to obtain a particular microstructure for the base alloy (e.g.: tempering treatment). The heat treatment operations can be performed in a vacuum, under neutral gas or even in a reducing atmosphere (presence of H2, for example).

In order to promote good adhesion, diffusion and/or pressure-reducing heat treatment operations 205 can optionally be performed on completion of the initial assembly treatment. With reference to FIG. 6, on completion of said step 205, the interface between the substrate 1 and the metal coating 5 follows a substantially smooth surface S′1.

As in the first embodiment, a mechanical or chemical finishing treatment operation 206 can be performed to finalise the improvement of the surface condition.

The embodiment examples of the method have been shown on a portion of surface S1 with reference to small-scale structures. It is clear that the method can be used to manufacture a part for which a determined portion of surface has to be treated, for example for working in particular conditions, or even for which the entire surface has to be treated.

1. Method for manufacturing a turbine engine part, said method comprising a step of producing said part by powder metallurgy using a material forming the substrate of said part, then a finishing operation comprising at least one first step, in which a determined material is deposited onto at least one surface (S1) of the substrate of said part after the powder metallurgy production step, and a second step corresponding to a heat treatment operation, so as to form a smooth coating for said surface (S1), characterised in that said determined material is a metal material, so as to form a smooth metal coating.

2. The method according to claim 1, wherein said metal material is deposited in the form of powder during said first finishing step.

3. The method according to claim 2, wherein a binding agent or adhesive is used during said first finishing step, so as to promote the adhesion of the metal powder material onto said surface (S1) of the substrate.

4. The method according to claim 2, wherein the material of the substrate is a determined metal or metal alloy and wherein said metal powder material comprises at least one first set of grains made up of a first metal or a first alloy of the same nature as the material of the substrate.

5. The method according to claim 2, wherein the heat treatment operation of said second finishing step is performed so as to melt at least one set of grains of the same nature in said metal powder material.

6. The method according to claim 4, wherein the first set of grains differs from the set of grains melted in said second finishing step.

7. The method according to claim 6, wherein, said surface (S1) of the substrate having a determined roughness (Rt), the particle size of said first set of grains is smaller than said roughness, preferably smaller than or equal to 53 μm, so as to form drops of liquid material properly filling the roughness of the surface (S1) of the substrate during said second finishing step.

8. The method according to claim 2, comprising a step of cleaning said surface (S1) of the substrate before said first finishing step, so as to promote the adhesion of said metal material on the substrate.

9. The method according to claim 2, wherein said first finishing step comprises at least one phase of depositing an adhesive agent onto said surface (S1) of the substrate prior to a phase of applying the powder of said metal material onto said surface (S1), so that the powder adheres to said surface (S1).

10. The method according to claim 2, wherein said first finishing step comprises a phase of producing a slurry with the powder of said metal material, using at least one binding agent and a solvent, and a phase of applying said slurry to said surface (S1) of the substrate, so that the powder deposit reaches the desired thickness for forming the coating.

11. The method according to claim 10, wherein, after the phase of applying said slurry to said surface (S1) of the substrate, the finishing operation comprises a step of heat-curing, so as to consolidate the powder deposit.

12. The method according to claim 1, wherein the finishing operation comprises a second heat treatment operation, so as to homogenise the thickness of the coating of said surface.

13. The method according to claim 12, wherein the second heat treatment operation comprises a brazing phase and a diffusion phase.

14. The method according to claim 1, wherein the finishing operation comprises a step of mechanical or chemical treatment of the coating of said surface.
